(19) United States
(12) Patent Application Publication
(10) Pub. No.: US 2026/0260440 A1
(43) Pub. Date: Sep. 3, 2026

(54) ENVIRONMENTAL CHARACTERISTIC VISUALIZATION

(71) Applicant: Apple Inc., Cupertino, CA (US)

(72) Inventors: Yutaka Yokokawa, Los Gatos, CA (US); Amrutha Hakkare Arunachala, Sunnyvale, CA (US); In Young Yang, Kirkland, WA (US); Joshua J. Frost, Aptos, CA (US); Julian K. Shutzberg, San Francisco, CA (US); Magnus H. Johnson, San Francisco, CA (US)

(21) Appl. No.: 19/460,627

(22) Filed: Jan. 27, 2026

Related U.S. Application Data
(60) Provisional application No. 63/756,652, filed on Feb. 10, 2025.

(51) Int. Cl. G06T 19/20

(52) U.S. Cl. CPC G06T 19/20; G06T 2219/2016

(57) ABSTRACT

In one implementation, a method of visualizing an environmental characteristic is performed by a device including a display, one or more processors, and non-transitory memory. The method includes displaying a virtual representation of a physical environment. The method includes obtaining, from a physical device at a device physical location in the physical environment, status information indicating a status of the physical device. The method includes displaying, at a device virtual location in the virtual representation of the physical environment corresponding to the device physical location in the physical environment, a virtual representation of the physical device. The method includes determining a plurality of values of an environmental characteristic of the physical environment at a plurality of environment physical locations in the physical environment, wherein the plurality of values are based at least in part on the status information. The method includes displaying, at a plurality of environment virtual locations in the virtual representation of the physical environment corresponding to the environment physical locations in the physical environment, indications of the plurality of values of the environmental characteristic.

### CROSS-REFERENCES TO RELATED APPLICATIONS

This application claims priority to U.S. Provisional App. No. 63/756,652, filed on Feb. 10, 2025, which is hereby incorporated by reference in its entirety.

### TECHNICAL FIELD

The present disclosure generally relates to systems, methods, and devices for visualizing an environmental characteristic of a physical environment.

### SUMMARY

In various implementations, a device displays a visualization of a physical environment such as a floorplan or a dollhouse. Further, the location of physical devices within the physical environment, such as lights, locks, or blinds, can be represented by representations of the physical devices at corresponding locations in the visualization of the physical environment.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIGS. 2A-2L illustrate an XR environment during various time periods in accordance with some implementations.

FIG. 3 is a flowchart representation of a method of visualizing an environmental characteristic of a physical environment in accordance with some implementations.

FIG. 4 is a block diagram of an example controller in accordance with some implementations.

FIG. 5 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying a status indicator. In various implementations, the method is performed by a device having a display, one or more processors, and non-transitory memory. The method includes displaying a virtual representation of a physical environment. The method includes obtaining, from a physical device at a device physical location in the physical environment, status information indicating a status of the physical device. The method includes displaying, at a device virtual location in the virtual representation of the physical environment corresponding to the device physical location in the physical environment, a virtual representation of the physical device. The method includes determining a plurality of values of an environmental characteristic of the physical environment at a plurality of environment physical locations in the physical environment, wherein the plurality of values are based at least in part on the status information. The method includes displaying, at a plurality of environment virtual locations in the virtual representation of the physical environment corresponding to the environment physical locations in the physical environment, indications of the plurality of values of the environmental characteristic.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, an electronic device can display a virtual representation of a physical environment with virtual representations of physical devices in the physical environment displayed at corresponding locations in the virtual representation of the physical environment. Further, these virtual representations of physical devices may indicate statuses of the physical devices. For example, a virtual representation of a light may be bright to indicate that the light has an “on” status and be dim to indicate that the light has an “off” status. Further, these virtual representations of physical devices may be interactive, acting as an affordance to change the status of the physical devices. For example, when a virtual representation of a light is activated, the electronic device may transmit a command to the light to change the status. In response to receiving such a command, the light may change status from “on” to “off” or vice versa.

In addition to displaying virtual representations of physical devices, in various implementations, the virtual representation of the physical environment is further displayed with a visualization of an environmental characteristic influenced by one or more of the physical devices. For example, a visualization of lighting in the physical environment (displayed with the virtual representation of the physical environment) may be displayed based on the status of one or more lights in the physical environment.

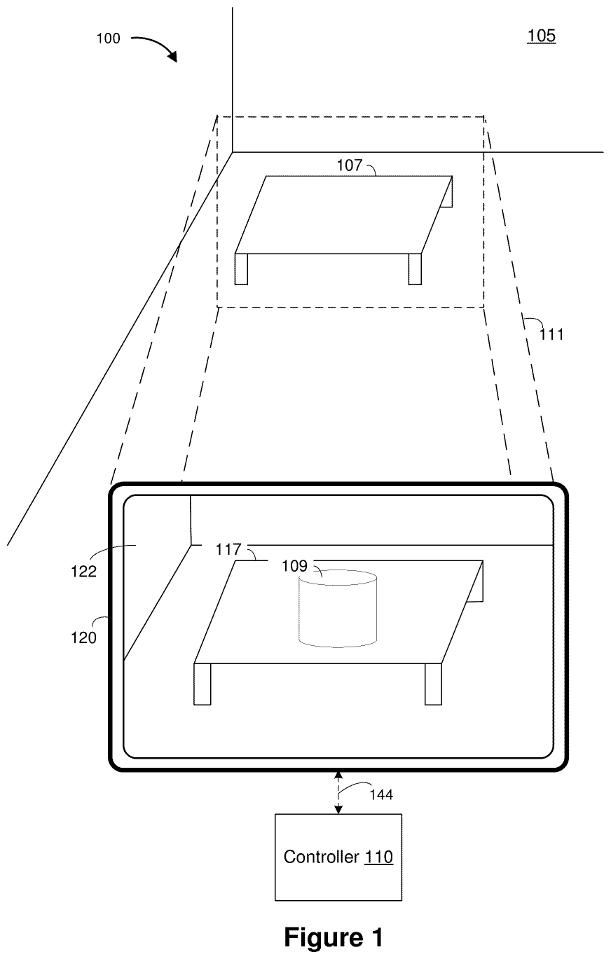

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

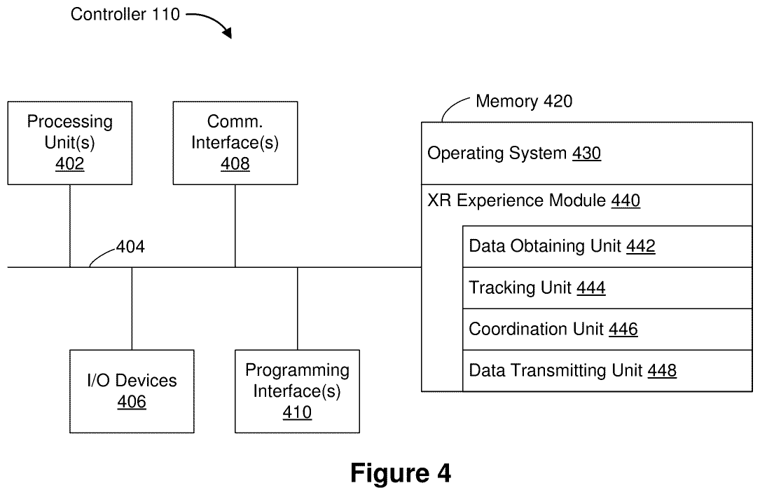

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 4. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

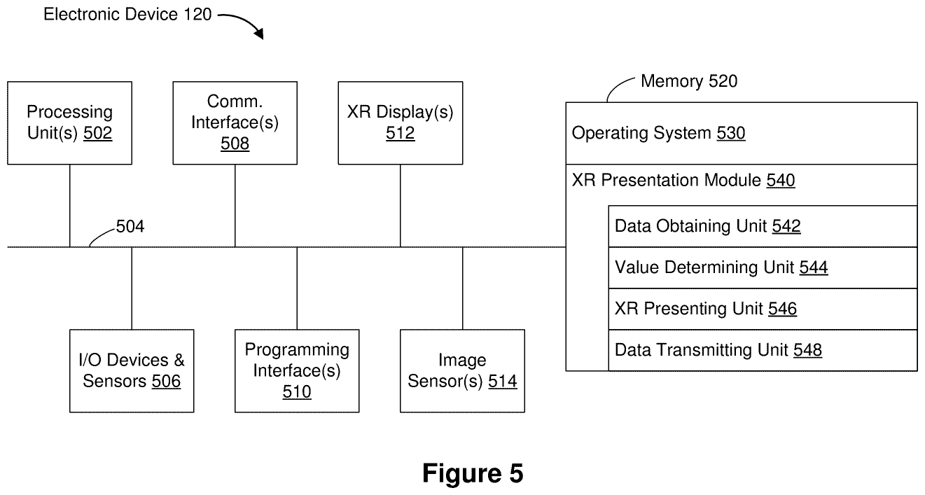

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is virtually or physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 5.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

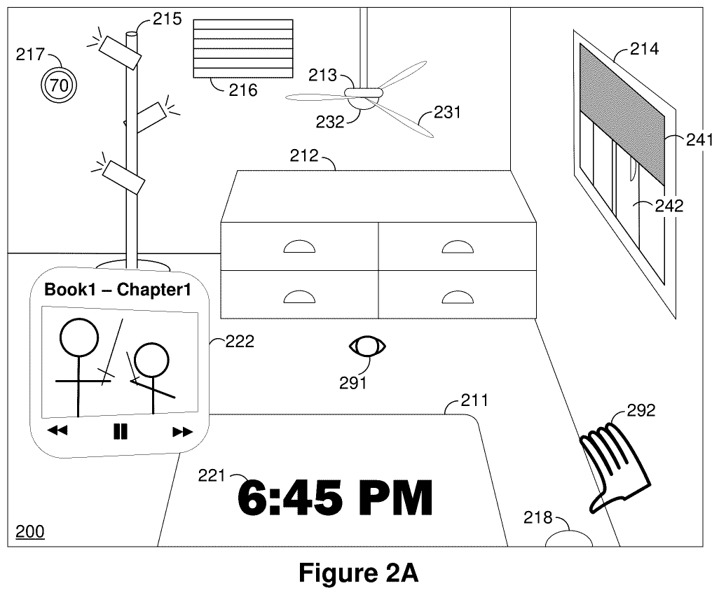

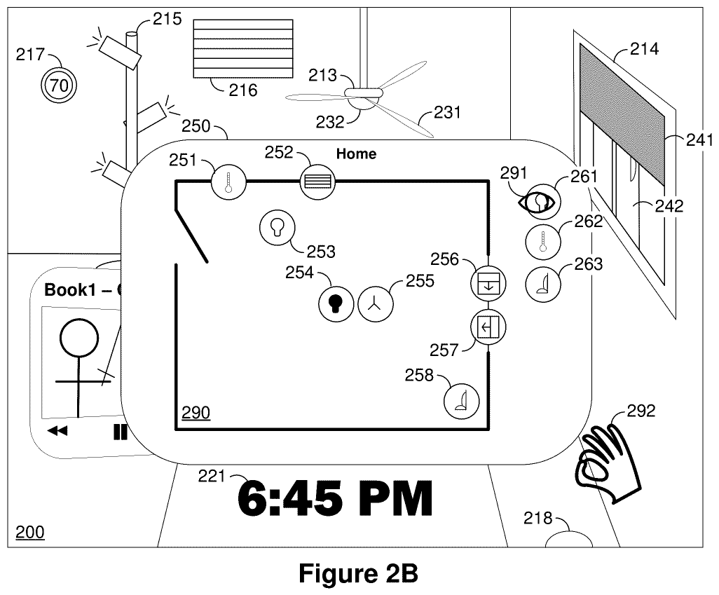

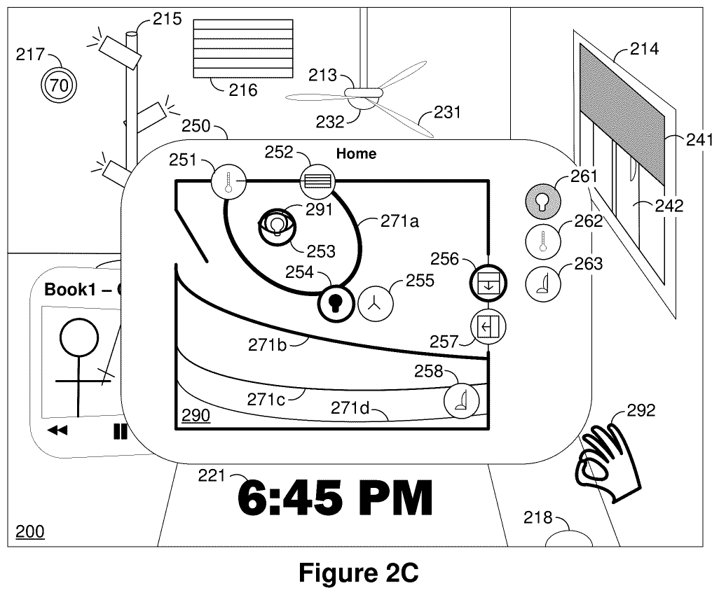

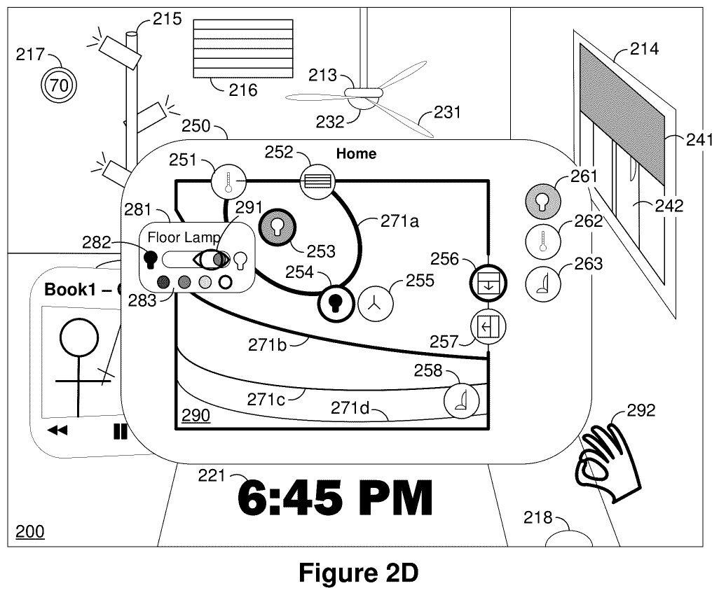

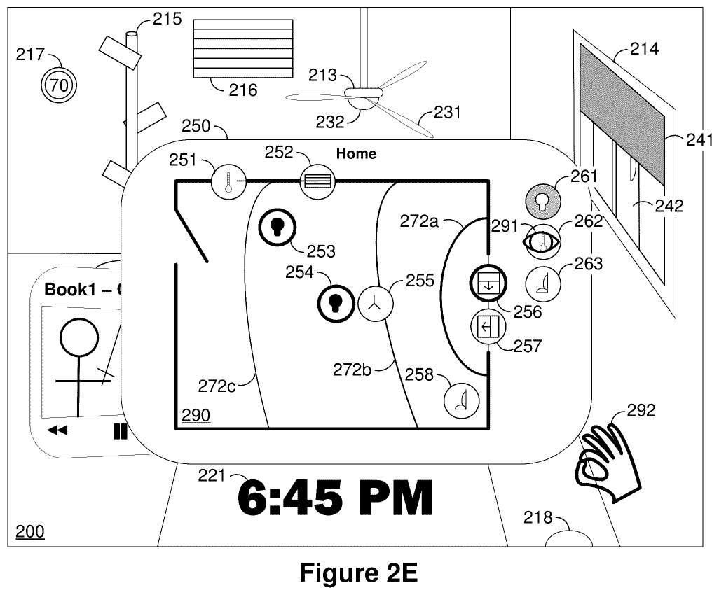

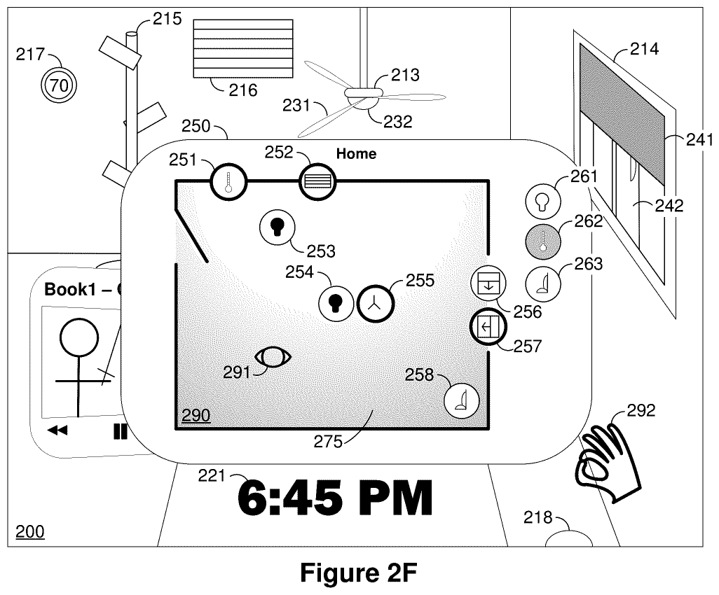

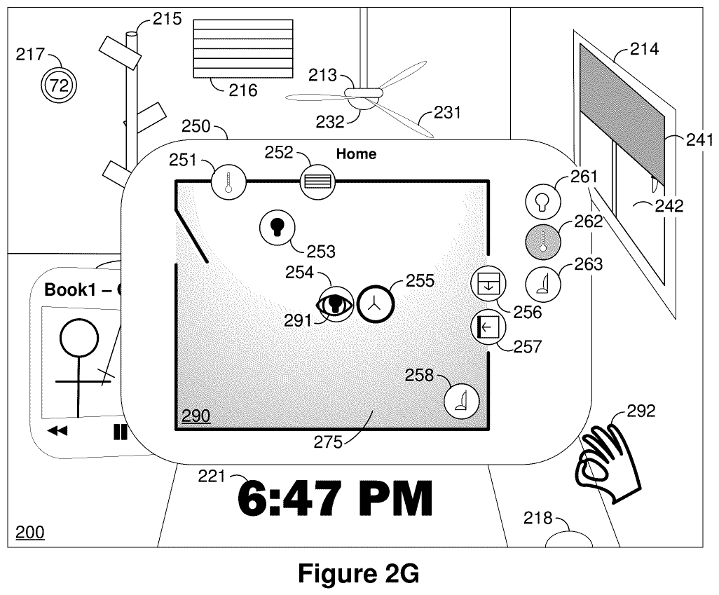

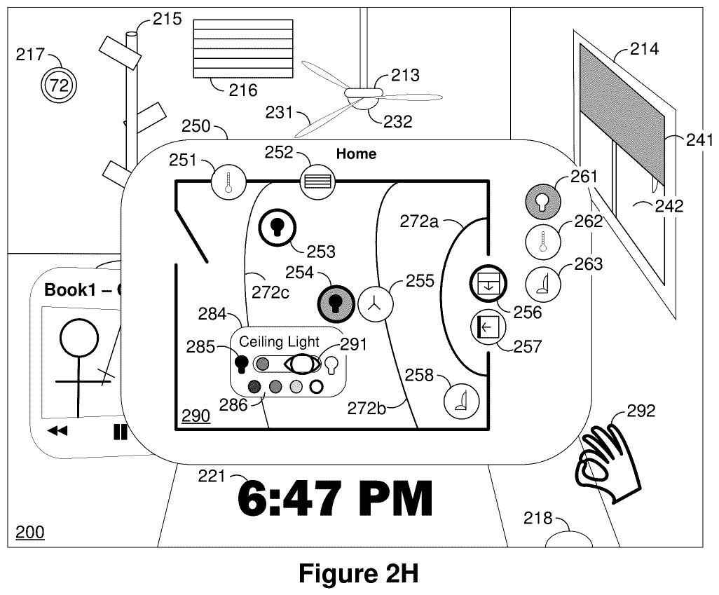

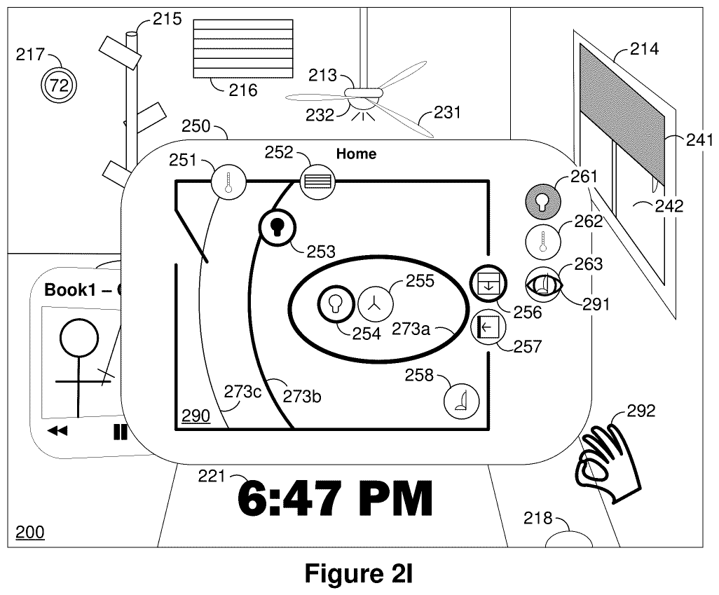

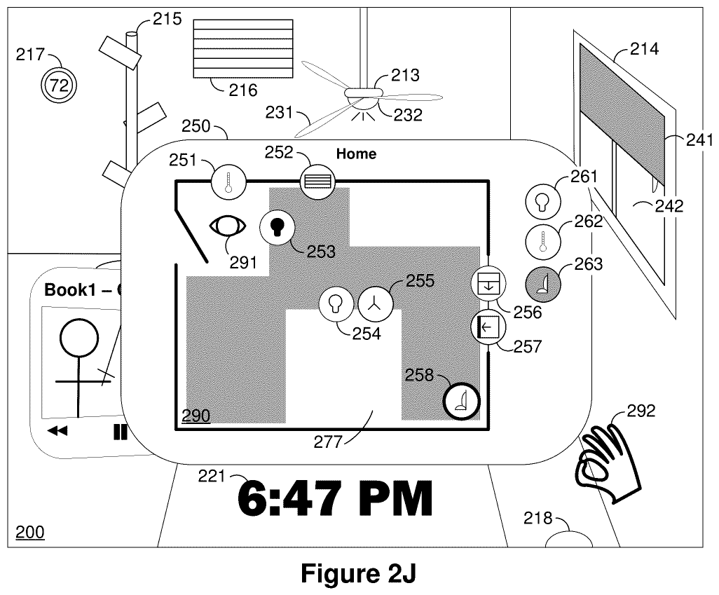

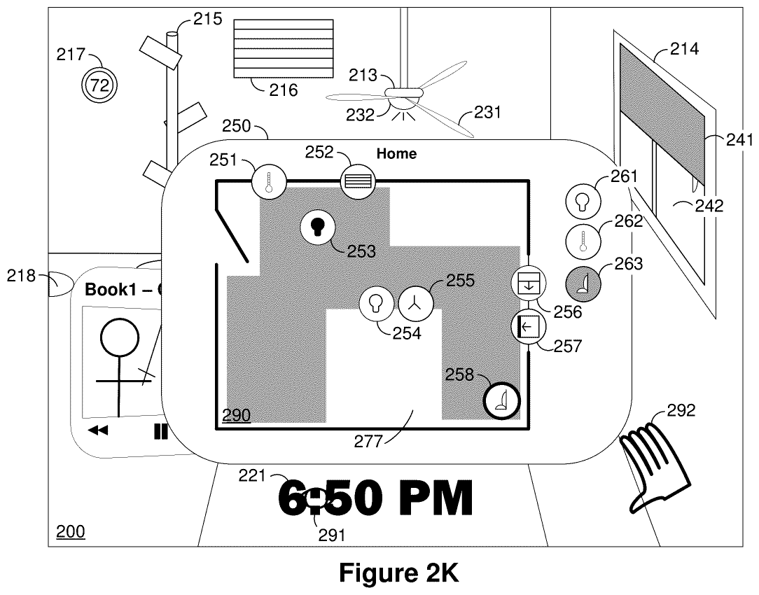

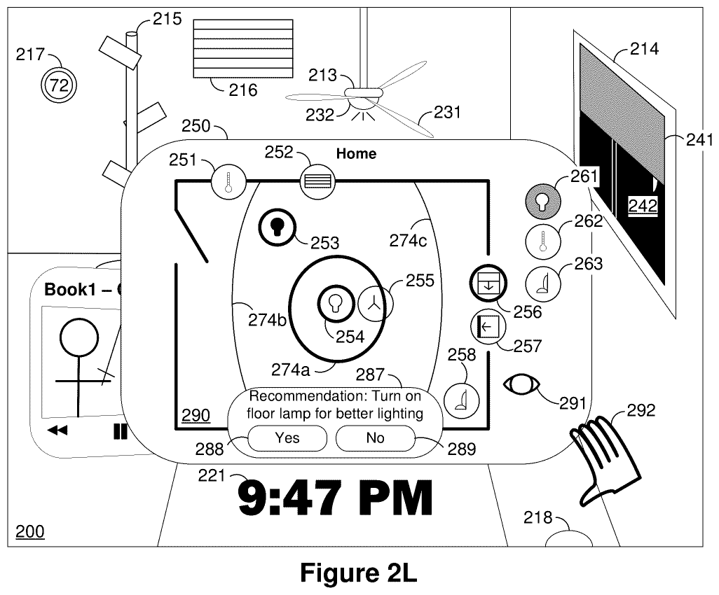

FIGS. 2A-2L illustrate an XR environment 200 based on a physical environment of a bedroom from the perspective of a user of an electronic device displayed, at least in part, by a display of an electronic device. In various implementations, the electronic device includes multiple displays (e.g., a left display positioned in front of a left eye of a user and a right display positioned in front of a right eye of the user) configured to provide a stereoscopic view of the XR environment 200. For ease of illustration, FIGS. 2A-2L illustrate the XR environment 200 as presented on a single one of the multiple displays.

In various implementations, the perspective of the user is from a location of an image sensor of the electronic device. For example, in various implementations, the electronic device is a handheld electronic device and the perspective of the user is from a location of the image sensor of the handheld electronic device directed towards the physical environment. In various implementations, the perspective of the user is from the location of a user of the electronic device. For example, in various implementations, the electronic device is a head-mounted electronic device and the perspective of the user is from a location of the user directed towards the physical environment, generally approximating the field-of-view of the user if the head-mounted electronic device were not present. In various implementations, the perspective of the user is from the location of an avatar of the user. For example, in various implementations, the XR environment 200 is a virtual environment and the perspective of the user is from the location of an avatar or other representation of the user directed towards the virtual environment.

FIGS. 2A-2L illustrate the XR environment 200 during a series of time periods. In various implementations, each time period is an instant, a fraction of a second, a few seconds, a few hours, a few days, or any length of time.

The XR environment 200 includes a plurality of objects, including one or more real objects (e.g., a bed 211, a dresser 212, a ceiling fixture 213, a window 214, a floor lamp 215, a vent 216, a thermostat 217, a robot vacuum 218, and a hand 292) and one or more virtual objects (e.g., a virtual clock 221 and a virtual audiobook player 222). The ceiling fixture 213 includes a ceiling fan 231 and a ceiling light 232. The window 214 includes blinds 241 and a shutter 242.

In various implementations, certain objects (such as the real objects and the virtual audiobook player 222) are presented at a location in the XR environment 200, e.g., at a location defined by three coordinates in a three-dimensional (3D) XR coordinate system. Accordingly, when the electronic device moves in the XR environment 200 (e.g., changes either position and/or orientation), the objects are moved on the display of the electronic device, but retain their (possibly time-dependent) location in the XR environment 200. Such virtual objects that, in response to motion of the electronic device, move on the display, but retain their position in the XR environment 200 are referred to as world-locked objects. In various implementations, certain virtual objects (such as the virtual clock 221) are displayed at locations on the display such that when the electronic device moves in the XR environment 200, the objects are stationary on the display on the electronic device. Such virtual objects that, in response to motion of the electronic device, retain their location on the display are referred to as head-locked objects or display-locked objects.

FIGS. 2A-2L illustrate a gaze location indicator 291 that indicates a gaze location of the user, e.g., where in the XR environment 200 the user is looking. Although the gaze location indicator 291 is illustrated in FIGS. 2A-2L, in various implementations, the gaze location indicator 291 is not displayed by the electronic device.

FIG. 2A illustrates the XR environment 200 during a first time period. During the first time period, the user is looking at a neutral location (e.g., the floor as indicated by the gaze location indicator 291) and the hand 292 is in a neutral position. During the first time period, the user requests that the electronic device display a virtual representation of the physical environment. In various implementations, the user requests such display verbally. In various implementations, the user requests such display by opening an application using the electronic device.

FIG. 2B illustrates the XR environment 200 during a second time period subsequent to the first time period. In response to the user request, the electronic device displays a visualization window 250 including a two-dimensional virtual representation of the physical environment as a floorplan 290. In particular, the floorplan 290 includes a scale diagram of the physical environment viewed from above with lines corresponding to walls, doors, and windows of the physical environment. Although the virtual representation of the physical environment in FIG. 2B includes only a single room (the bedroom), it is to be appreciated that the virtual representation of the physical environment could include multiple rooms. In various implementations, a user can change the size and/or location of the virtual representation by changing the size and/or location of the window in the XR environment 200.

Although the virtual representation of the physical environment in FIG. 2B is a floorplan 290 displayed in a window, in various implementations, the virtual representation of the physical environment is a three-dimensional virtual representation in the form of a dollhouse. In particular, the dollhouse is a scale model of the physical environment viewed from a particular angle with surfaces corresponding to walls, doors, and windows of the physical environment. When the virtual representation of the physical environment is a dollhouse, the virtual representation may be displayed as a world-locked virtual object in the XR environment without a window. In various implementations, a user can change the size and/or location of the virtual representation as might be done on any other world-locked virtual object.

In addition to the floorplan 290, the visualization window 250 includes virtual representations of physical devices in the physical environment displayed at locations in the floorplan 290 corresponding to locations of the physical devices in the physical environment. For example, the visualization window 250 includes a thermostat virtual representation 251 representing the thermostat 217, a vent virtual representation 252 representing the vent 216, a floor lamp virtual representation 253 representing the floor lamp 215, a ceiling light virtual representation 254 representing the ceiling light 232, a ceiling fan virtual representation 255 representing the ceiling fan 231, a blinds virtual representation 256 representing the blinds 241, a shutter virtual representation 257 representing the shutter 242, and a robot vacuum virtual representation 258 representing the robot vacuum 218.

In various implementations, the virtual representations indicate a status of a corresponding physical device. For example, in FIG. 2B, the floor lamp virtual representation 253 includes a bright bulb to indicate that the floor lamp 215 is on, whereas the ceiling light virtual representation 254 includes a dark bulb to indicate that the ceiling light 232 is off. As another example, the ceiling fan virtual representation 255 shows static blades to indicate that the ceiling fan 231 is off, but may show moving blades to indicate when the ceiling fan 231 is on. As another example, the blinds virtual representation 256 shows a square halfway filled to indicate that the blinds 241 are halfway lowered, but may show an empty square to indicate when the blinds 241 are fully raised or a full square to indicate when the blinds 241 are fully lowered.

The visualization window 250 further includes a plurality of environmental characteristic affordances 261-263 which, when selected, overlay upon the floorplan 290 a visualization of an environmental characteristic of the physical environment. For example, the visualization window 250 includes a lighting affordance 261 which, when selected, overlays a visualization of lighting of the physical environment. The visualization window 250 includes a temperature affordance 262 which, when selected, overlays a visualization of temperature of the physical environment. The visualization window 250 includes a cleanliness affordance 263 which, when selected, overlays a visualization of cleanliness of the physical environment. Although the visualization window 250 of FIG. 2B only shows three environmental characteristic affordances 261-263, it is to be appreciated that the visualization window could have any number of environmental characteristic affordances, including those that show loudness of sound, wireless signal strength, air quality, humidity, etc.

During the second time period, the user activates the lighting affordance 261 (e.g., by gazing at the lighting affordance 261 as indicated by the gaze location indicator 291 and performing a gesture with the hand 292).

FIG. 2C illustrates the XR environment during a third time period subsequent to the second time period. During the third time period, in response to detecting activation of the lighting affordance 261, the visualization window 250 includes, overlaid on the floorplan 290, a visualization of lighting of the physical environment in the form of a contour map including a first set of contour lines 271a-271d. Although the visualization of lighting in FIG. 2C is illustrated as a contour map, in various implementations, the visualization of lighting is a heat map or any other visualization indicating various values at various respective locations in the floorplan 290. In FIG. 2C, to indicate that the lighting affordance 261 is selected and a visualization of lighting is being displayed, the lighting affordance 261 is displayed in a different manner than in FIG. 2B. In particular, whereas in FIG. 2B, the background of the lighting affordance 261 is white, in FIG. 2C, the background of the lighting affordance 261 is gray.

The visualization of lighting is based on the status of certain physical devices having corresponding virtual representations. In particular, the visualization of lighting is based on the status of the floor lamp 215, the ceiling light 232, and the blinds 241. Accordingly, the corresponding floor lamp virtual representation 253, ceiling light virtual representation 254, and blinds virtual representation 256 are displayed in a different manner than in FIG. 2B. In particular, whereas in FIG. 2B, the representations have a thin line width, in FIG. 2C, the representations have a thick line width. Thus, a user can quickly determine which physical devices are affecting the lighting in the physical environment (and corresponding visualization). For example, because the floor lamp 215 is on and the ceiling light 232 is off, a first contour line 271a of the first set of contour lines 271a-271d surrounds the floor lamp virtual representation 253. The first contour line 271a is stretched towards the blinds virtual representation 256 as light is entering through the window 214 and partially lowered blinds 241.

During the third time period, the user activates the floor lamp virtual representation 253 (e.g., by gazing at the floor lamp virtual representation 253 as indicated by the gaze location indicator 291 and performing a gesture with the hand 292).

FIG. 2D illustrates the XR environment 200 during a fourth time period subsequent to the third time period. During the fourth time period, in response to detecting selection of the floor lamp virtual representation 253, the visualization window 250 includes a floor lamp window 281. The floor lamp window 281 includes an on/off affordance 282 indicating (and facilitating a change in) an on/off status of the floor lamp 215 and a color affordance 283 indicating (and facilitating for a change in) a color status of the floor lamp 215. Further, in response to detecting selection of the floor lamp virtual representation 253, the floor lamp virtual representation 253 is displayed in a different manner than in FIG. 2D. In particular, whereas in FIG. 2C, the background of the floor lamp virtual representation 253 is white, in FIG. 2D, the background of the floor lamp virtual representation 253 is gray.

During the fourth time period, the user activates the on/off affordance 282 (e.g., by gazing at the on/off affordance 282 as indicated by the gaze location indicator 291 and performing a gesture with the hand 292).

Although FIGS. 2C and 2D illustrate a first user input activating the floor lamp virtual representation 253 to open the floor lamp window 281 and a second user input activating the on/off affordance 282 to change the status of the floor lamp 215, in various implementations, the status of a physical device is changed with only a single interaction with the corresponding virtual representation. For example, in various implementations, the status of the floor lamp 215 is changed with only a single interaction with the floor lamp virtual representation 253. This may be particularly useful for devices having only two states, such as on/off, opened/closed, or locked/unlocked.

FIG. 2E illustrates the XR environment 200 during a fifth time period subsequent to the fourth time period. During the fifth time period, in response to detecting activation of the on/off affordance 282, the electronic device transmits a command to the floor lamp 215 to change from an “on” status to an “off” status. In response to receiving such a command, the floor lamp 215 changes its status. Accordingly, in FIG. 2E, the floor lamp 215 is off (as seen in the physical environment and as shown by the floor lamp virtual representation 253). Further, the visualization of lighting in the physical environment is changed from the first set of contour lines to a second set of contour lines 272a-272c. In particular, a first contour line 272a of the second set of contour lines 272a-272c partially inscribes the window 214, the only source of light.

During the fifth time period, the user activates the temperature affordance 262 (e.g., by gazing at the temperature affordance 262 as indicated by the gaze location indicator 291 and performing a gesture with the hand 292).

FIG. 2F illustrates the XR environment 200 during a sixth time period subsequent to the fifth time period. During the sixth time period, in response to detecting activation of the temperature affordance 262, the visualization of lighting of the physical environment is replaced with a visualization of temperature of the physical environment in the form of a heat map 275. In FIG. 2F, to indicate that the temperature affordance 262 is selected and a visualization of temperature is being displayed, the temperature affordance 262 is displayed in a different manner than in FIG. 2D (and the lighting affordance 261 reverts to being displayed in the original manner).

The visualization of temperature is based on the status of certain physical devices having corresponding virtual representations. In particular, the visualization of temperature is based on the status of the thermostat 217, the vent 216, the ceiling fan 231, and the shutter 242. Accordingly, the corresponding thermostat virtual representation 251, vent virtual representation 252, ceiling fan virtual representation 255, and shutter virtual representation 257 are displayed in a different manner than in FIG. 2D (and the other representations revert to being displayed in the original manner). Thus, a user can quickly determine which physical devices are affecting the temperature in the physical environment (and corresponding visualization). For example, because the vent 216 is open and the shutter 242 is partially open, the warmest spot in the physical environment is represented by the lower left corner of the heat map 275.

During the sixth time period, the user activates the heat map 275 (e.g., by gazing at the heat map 275 as indicated by the gaze location indicator 291 and performing a gesture with the hand 292) and requests an increase in the temperature. Thus, whereas in FIG. 2D, a user changes an environmental characteristic in the physical environment by manipulating a single device via an affordance, in FIG. 2F, a user can change an environmental characteristic in the physical environment by manipulating the visualization of the environmental characteristic.

FIG. 2G illustrates the XR environment 200 at a seventh time period subsequent to the sixth time period. In response to detecting the user activating the heat map 275 and requesting an increase in temperature, the electronic device transmits a command to the thermostat 217 to change a temperature status from “70” to “72” and transmits a command to the shutter 242 to change an opening status from “partially open” to “closed”. Thus, during the seventh time period, the thermostat 217 is set to 72 and the shutter 242 is closed.

During the seventh time period, the user activates the ceiling light virtual representation 254 (e.g., by gazing at the ceiling light virtual representation 254 as indicated by the gaze location indicator 291 and performing a gesture with the hand 292.

FIG. 2H illustrates the XR environment 200 at an eighth time period subsequent to the seventh time period. During the eighth time period, in response to detecting activation of the ceiling light virtual representation 254, the temperature affordance 262 is unselected and the lighting affordance 261 is selected. Accordingly, the visualization of temperature in the form of a heat map 275 is replaced with the visualization of lighting in the form of the second set of contour lines 272a-272c. Further, during the eighth time period, in response to detecting selection of the ceiling light virtual representation 254, the visualization window 250 includes a ceiling light window 284. The ceiling light window 284 includes an on/off affordance 285 indicating (and facilitating a change in) an on/off status of the ceiling light 232 and a color affordance 286 indicating (and facilitating for a change in) a color status of the ceiling light 232. Further, in response to detecting selection of the ceiling light virtual representation 254, the ceiling light virtual representation 254 is displayed in a different manner than in FIG. 2G.

During the eighth time period, the user activates the on/off affordance 285 (e.g., by gazing at the on/off affordance 285 as indicated by the gaze location indicator 291 and performing a gesture with the hand 292).

FIG. 2I illustrates the XR environment 200 during a ninth time period subsequent to the eighth time period. During the ninth time period, in response to detecting activation of the on/off affordance 285, the electronic device transmits a command to the ceiling light 232 to change from an “off” status to an “on” status. In response to receiving such a command, the ceiling light 232 changes its status. Accordingly, in FIG. 2I, the ceiling light 232 is on (as seen in the physical environment and as shown by the ceiling light virtual representation 254. Further, the visualization of lighting in the physical environment is changed from the second set of contour lines to a third set of contour lines 273a-273c. In particular, a first contour line 273a of the third set of contour lines 273a-273c surrounds the ceiling light virtual representation 254. The first contour line 271a is stretched towards the blinds virtual representation 256 as light is entering through the window 214 and partially lowered blinds 241.

During the ninth time period, the user activates the cleanliness affordance 263 (e.g., by gazing at the cleanliness affordance 263 as indicated by the gaze location indicator 291 and performing a gesture with the hand 292).

FIG. 2J illustrates the XR environment 200 during a tenth time period subsequent to the ninth time period. During the tenth time period, in response to detecting activation of the cleanliness affordance 263, the visualization of lighting of the physical environment is replaced with a visualization of cleanliness of the physical environment in the form of a binary map 277 in which areas that have been recently cleaned by the robot vacuum 218 are shown in gray and those that have not are shown in white. In FIG. 2J, to indicate that the cleanliness affordance 263 is selected and a visualization of cleanliness is being displayed, the cleanliness affordance 263 is displayed in a different manner than in FIG. 2I (and the lighting affordance 261 reverts to being displayed in the original manner).

During the tenth time period, the user activates the binary map 277 (e.g., by gazing at the binary map 277 as indicated by the gaze location indicator 291 and performing a gesture with the hand 292) and requests cleaning in an area of physical environment (e.g., an area behind the door the robot vacuum previously found inaccessible) by indicating the corresponding area of the floorplan 290 (or binary map 277 overlaid thereon).

FIG. 2K illustrates the XR environment 200 at an eleventh time period subsequent to the tenth time period. In response to detecting the user activating the binary map 277 and requests cleaning in an area of physical environment, the electronic device transmits a command to the robot vacuum 218 to clean the area of the physical environment. Thus, during the eleventh time period, the robot vacuum 218 is in the area of the physical environment and the binary map 277 shows the area has been partially cleaned. In various implementations, robot vacuum virtual representation 258 representing the robot vacuum 218 is moved to the corresponding area of the floorplan 290. In various implementations, such as is illustrated in FIG. 2K, the robot vacuum virtual representation 258 is stationary indicating the location of a home or dock of the robot vacuum 218.

FIG. 2L illustrates the XR environment 200 at a twelfth time period subsequent to the eleventh time period. In response to time passing, the lighting conditions in the physical environment have changed as light is no longer passing through the window 214. In various implementations, the visualization window 250 is displayed in response to a change in conditions (rather than user input). For example, in FIG. 2L, the visualization window 250 is displayed in response to the change in lighting conditions. Further, the visualization window 250 includes a recommendation window 287 including a recommendation to improve the lighting conditions by turning on the floor lamp 215. The recommendation window 287 includes a yes affordance 288 which, when activated, turns on the floor lamp 215 and a no affordance 289 which, when activated, dismisses the recommendation window 287 (and, in various implementations, the visualization window 250).

In various implementations, the electronic device can recommend moving a physical object. For example, the electronic device can recommend moving a router to obtain better wireless network coverage. Similarly, in various implementations, the electronic device can recommend adding a physical object to the physical environment. For example, the electronic device can recommend installing a light fixture to obtain better lighting conditions.

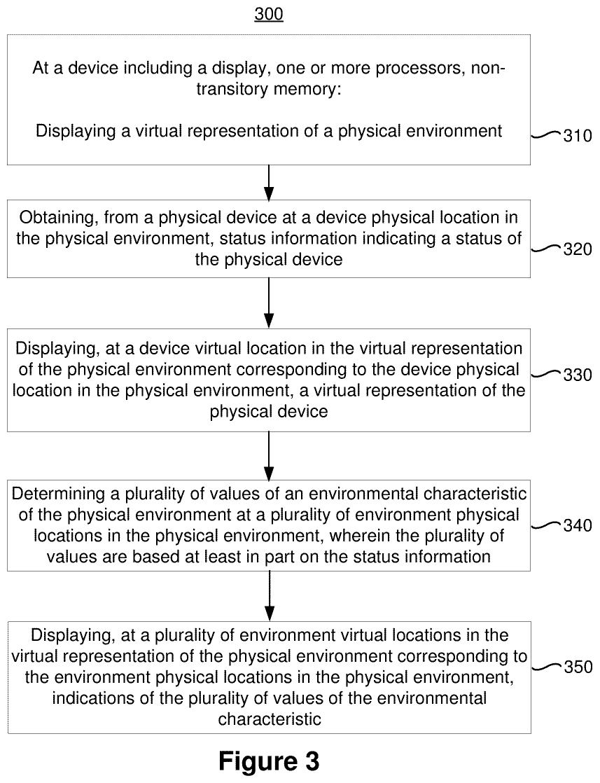

FIG. 3 is a flowchart representation of a method 300 of displaying a virtual representation of a physical environment in accordance with some implementations. In various implementations, the method 300 is performed by an electronic device, such as the electronic device 120 of FIG. 1. In various implementations, the method 300 is performed by a device having a display, one or more processors, and non-transitory memory. In some implementations, the method 300 is performed by processing logic, including hardware, firmware, software, or a combination thereof. In some implementations, the method 300 is performed by a processor executing instructions (e.g., code) stored in a non-transitory computer-readable medium (e.g., a memory).

The method 300 begins, in block 310, with the device displaying a virtual representation of a physical environment. For example, in FIGS. 2B-2L, the electronic device displays the floorplan 290 in the visualization window 250. In various implementations, displaying the virtual representation of the physical environment includes displaying a scale diagram or model of the physical environment. For example, in various implementations, displaying the virtual representation of the physical environment includes displaying a two-dimensional floorplan. In various implementations, displaying the virtual representation of the physical environment includes displaying a three-dimensional dollhouse.

In various implementations, displaying the virtual representation of the physical environment includes displaying the virtual representation of the physical environment in association with the physical environment as a world-locked virtual object. For example, in FIGS. 2B-2L, the electronic device displays the visualization window 250 as a world-locked virtual object in association with the bedroom. In various implementations, displaying the virtual representation of the physical environment in association with the physical environment includes compositing a rendering of the virtual representation of the physical environment with an image of the physical environment and displaying the composite on an opaque display. In various implementations, displaying the virtual representation of the physical environment in association with the physical environment includes displaying a rendering of the virtual representation of the physical environment on a transparent display while the user is in the physical environment.

In various implementations, the world-locked virtual object is displayed with an orientation that matches the physical environment. For example, when the virtual representation of the physical environment is a three-dimensional dollhouse, the portion of the dollhouse representing a wall is displayed parallel to the wall and closest to the wall. Similarly, the portion of the dollhouse representing an opposite wall is displayed parallel to the opposite wall and closest to the opposite wall. As another example, when the virtual representation of the physical environment is a two-dimensional floorplan, the floorplan is displayed as a horizontal plane parallel to the floor and the portion of the floorplan representing a wall is displayed parallel to the wall and closest to the wall. Similarly, the portion of the floorplan representing an opposite wall is displayed parallel to the opposite wall and closest to the opposite wall. As another example, when the virtual representation of the physical environment is a two-dimensional floorplan, the floorplan is displayed as a vertical plane perpendicular to the floor and the portion of the floorplan representing a wall is displayed parallel to the wall and closest to the wall. Similarly, the portion of the floorplan representing an adjoining wall is displayed at the top or bottom of the floorplan.

Although FIGS. 2A-2L illustrate displaying a virtual representation of the physical environment in association with the physical environment, in various implementations, the virtual representation of the physical environment is not displayed in association with the physical environment. In various implementations, the virtual representation of the physical environment is displayed while the device is remote from the physical environment (e.g., in a different physical environment). In various implementations, the virtual representation of the physical environment is displayed in association with the different physical environment. In various implementations, the virtual representation of the physical environment is displayed without association with any physical environment, e.g., as an application on a phone or tablet.

The method 300 continues, in block 320, with the device obtaining, from a physical device at a device physical location in the physical environment, status information indicating a status of the physical device. In various implementations, obtaining the status information includes transmitting a query to the physical device and receiving, in response to the query, the status information. For example, in FIG. 2B, the electronic device obtains, from the floor lamp 215, status information indicating that the floor lamp 215 is on.

The method 300 continues, in block 330, with the device displaying, at a device virtual location in the virtual representation of the physical environment corresponding to the device physical location in the physical environment, a virtual representation of the physical device. For example, in FIG. 2B, the electronic device displays the floor lamp virtual representation 253 at a location in the floorplan 290 corresponding to a location of the floor lamp 215 in the bedroom. In various implementations, displaying the virtual representation of the physical device is based at least in part on the status information. For example, in FIG. 2B, because the floor lamp 215 is on, the floor lamp virtual representation 253 includes a bright light bulb. In contrast, because the ceiling light 232 is off, the ceiling light virtual representation 254 includes a dark light bulb.

In various implementations, such as illustrated in FIGS. 2B-2L, the virtual representation of the physical device is an icon. In various implementations, the virtual representation of the physical device is a scale diagram or model of the physical device. In various implementations, the virtual representation of the physical device is a scale diagram or model of a physical device having the same device type as the physical device. For example, in various implementations, the virtual representation of the floor lamp 215 may be diagram of small lamp, but not necessarily the three-bulbed light fixture illustrated in FIGS. 2A-2L.

The method 300 continues, in block 340, with the device determining a plurality of values of an environmental characteristic of the physical environment at a plurality of environment physical locations in the physical environment, wherein the plurality of values are based at least in part on the status information.

In various implementations, determining the plurality of values of the environmental characteristic includes determining a plurality of lighting values of the physical environment at the plurality of environment physical locations in the physical environment. For example, in FIG. 2C, the electronic device determines a plurality of lighting values of the physical environment at a plurality of locations in the bedroom based in part on the status of the floor lamp 215 (e.g., “on”), the status of the ceiling light 232 (e.g., “off”), and the status of blinds 241 (e.g., “partially open”) and displays a contour map based on those values.

In various implementations, determining the plurality of values of the environmental characteristic includes determining a plurality of temperature values of the physical environment at the plurality of environment physical locations in the physical environment. For example, in FIG. 2F, the electronic device determines a plurality of temperature values of the physical environment at a plurality of locations in the bedroom based in part on the status of the thermostat 217 (e.g., “70”), the status of the vent 216 (e.g., “open”), the status of the ceiling fan (e.g., “off”), and the status of shutter 242 (e.g., “partially open”) and displays a heat map based on those values.

In various implementations, the environmental characteristic is a lighting characteristic, temperature characteristic, a sound characteristic, a wireless signal characteristic, an air quality characteristic, a humidity characteristic, etc. In various implementations, the lighting characteristic includes brightness and/or color. Generally, in various implementations, determining the plurality of values of the environmental characteristic includes simulating or modelling the physical environment based on the status information and, in various implementations, other available information.

In various implementations, determining the plurality of values of the environmental characteristic is further based on a model of the physical environment. For example, in various implementations, when the environmental characteristic is a loudness of sound at the plurality of environmental physical locations, the device models sound propagation throughout the physical environment based on wall texture, floor texture, wall material (e.g., wood or concrete), etc.

In various implementations, determining the plurality of values of the environmental characteristic is further based on a time of day. For example, in FIG. 2C, the lighting values are based on light passing through the partially opened blinds 241. The amount of light passing through the partially opened blinds 241 is based on the time of day.

In various implementations, determining the plurality of values of the environmental characteristic is further based on weather information. For example, as noted above, in FIG. 2C, the lighting values are based on light passing through the partially opened blinds 241. The amount of light passing through the partially opened blinds 241 is based on the weather. Similarly, in FIG. 2F, the temperature values are based on heat passing through the partially opened shutter 242. The amount of heat passing through the partially opened shutter 242 is based on the weather.

In various implementations, determining the plurality of values of the environmental characteristic is further based on sensor data. For example, in FIG. 2F, in various implementations, the vent 216 includes a thermometer. Accordingly, the temperature values are based on temperature information obtained by the vent 216 from the thermometer and transmitted to the electronic device.

The method 300 continues, in block 350, with the device displaying, at a plurality of environment virtual locations in the virtual representation of the physical environment corresponding to the environment physical locations in the physical environment, indications of the plurality of values of the environmental characteristic. In various implementations, displaying the indications of the plurality of values of the environmental characteristic includes displaying a contour map. For example, in FIG. 2C, the electronic device displays a contour map of lighting values. In various implementations, displaying the indications of the plurality of values of the environmental characteristic includes displaying a heat map. For example, in FIG. 2F, the electronic device displays a heat map of temperature values.

In various implementations, the virtual representation of the physical device is an affordance to change the status of the physical device. For example, in FIG. 2E, in response to user input directed to the floor lamp virtual representation 253, the status of the floor lamp 215 is changed from an “on” status to an “off” status. Accordingly, in various implementations, the method 300 includes receiving user input directed to the virtual representation of the physical device and, in response to receiving the user input, transmitting, to the physical device, a command to change the status of the physical device.

In various implementations, the virtual representation of the environmental characteristic is also an affordance to change the status of the physical device. For example, in FIG. 2G, in response to user input directed to the heat map 275, the status of the thermostat 217 is changed from “70” to “72” and the status of the shutter 242 is changed from “partially open” to “closed”). Accordingly, in various implementations, the method 300 includes receiving user input directed to the indications of the plurality of values of the environmental characteristic and, in response to receiving the user input, transmitting, to the physical device, a command to change the status of the physical device.

In various implementations, changing the status of a physical device changes the visualization of the environmental characteristic of the physical environment. For example, in FIG. 2E, in response to the floor lamp 215 changing from an “on” status to an “off” status the first set of contour lines 271a-271d are replaced with the second set of contour lines 272a-272c. Accordingly, in various implementations, the method 300 includes obtaining, from the physical device, updated status information indicating an updated status of the physical device. Further, the method 300 includes determining a plurality of updated values of the environmental characteristic of the physical environment at the plurality of environment physical locations in the physical environment, wherein the plurality of updated values are based at least in part on the updated status information. Further, the method 300 includes displaying, at the plurality of environment virtual locations in the virtual representation of the physical environment, indications of the plurality of updated values of the environmental characteristic.

In various implementations, the plurality of values of the environmental characteristic of the physical environment is based on the status of more than one physical device. For example, in FIG. 2C, the electronic device determines the plurality of lighting values of the physical environment at a plurality of locations in the bedroom based in part on the status of the floor lamp 215 (e.g., “on”), the status of the ceiling light 232 (e.g., “off”), and the status of blinds 241 (e.g., “partially open”) and displays a contour map based on those values. As another example, in FIG. 2F, the electronic device determines the plurality of temperature values of the physical environment at a plurality of locations in the bedroom based in part on the status of the thermostat 217 (e.g., “70”), the status of the vent 216 (e.g., “open”), the status of the ceiling fan (e.g., “off”), and the status of shutter 242 (e.g., “partially open”) and displays a heat map based on those values.

Accordingly, in various implementations, the method 300 further includes obtaining additional status information from an additional physical device at an additional device physical location in the physical environment and displaying, at an additional device virtual location in the virtual representation of the physical environment corresponding to the additional device physical location in the physical environment, an additional virtual representation of the additional physical device. Further, determining the plurality of values of the environmental characteristic of the physical environment, in block 350, is further based on the additional status information.

In various implementations, the device can display virtual representations of multiple environmental characteristics. In various implementations, the virtual representations are displayed separately and sequentially, such as in FIG. 2C and FIG. 2F. However, in various implementations, visualizations of multiple environmental characteristics are displayed simultaneously. For example, a virtual representation of lighting on a first floorplan may be displayed next to a virtual representation of temperature on a second floorplan. In various implementations, virtual representations of multiple environmental characteristics are displayed simultaneously on the same floorplan. For example, a virtual representation of lighting may be displayed as a contour map and a virtual representation of temperature may be displayed as a heat map. As another example, a virtual representation of temperature may be displayed as a blue heat map and a virtual representation of humidity may be displayed as a red heat map. Thus, where temperature and humidity are both high, the floorplan is purple; where temperature is high and humidity is low, the floorplan is blue; where temperature is low and humidity is high, the floorplan is red; and where temperature and humidity are both low, the floorplan is a default color (e.g., black or white).

Accordingly, in various implementations, the method 300 further includes obtaining, from an additional physical device at an additional device physical location in the physical environment, additional status information indicating a status of the additional physical device. The method 300 includes displaying, at an additional device virtual location in the virtual representation of the physical environment corresponding to the additional device physical location in the physical environment, an additional virtual representation of the additional physical device. The method 300 includes determining an additional plurality of values of an additional environmental characteristic of the physical environment at the plurality of environment physical locations in the physical environment, wherein the additional plurality of values are based at least in part on the additional status information. The method 300 includes displaying, at the plurality of environment virtual locations in the virtual representation of the physical environment, indications of the additional plurality of values of the additional environmental characteristic.

FIG. 4 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 402 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 406, one or more communication interfaces 408 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 410, a memory 420, and one or more communication buses 404 for interconnecting these and various other components.

In some implementations, the one or more communication buses 404 include circuitry that interconnects and controls communications between system components. In some implementations, the one or more I/O devices 406 include at least one of a keyboard, a mouse, a touchpad, a joystick, one or more microphones, one or more speakers, one or more image sensors, one or more displays, and/or the like.

The memory 420 includes high-speed random-access memory, such as dynamic random-access memory (DRAM), static random-access memory (SRAM), double-data-rate random-access memory (DDR RAM), or other random-access solid-state memory devices. In some implementations, the memory 420 includes non-volatile memory, such as one or more magnetic disk storage devices, optical disk storage devices, flash memory devices, or other non-volatile solid-state storage devices. The memory 420 optionally includes one or more storage devices remotely located from the one or more processing units 402. The memory 420 comprises a non-transitory computer readable storage medium. In some implementations, the memory 420 or the non-transitory computer readable storage medium of the memory 420 stores the following programs, modules and data structures, or a subset thereof including an optional operating system 430 and an XR experience module 440.

The operating system 430 includes procedures for handling various basic system services and for performing hardware dependent tasks. In some implementations, the XR experience module 440 is configured to manage and coordinate one or more XR experiences for one or more users (e.g., a single XR experience for one or more users, or multiple XR experiences for respective groups of one or more users). To that end, in various implementations, the XR experience module 440 includes a data obtaining unit 442, a tracking unit 444, a coordination unit 446, and a data transmitting unit 448.

In some implementations, the data obtaining unit 442 is configured to obtain data (e.g., presentation data, interaction data, sensor data, location data, etc.) from at least the electronic device 120 of FIG. 1. To that end, in various implementations, the data obtaining unit 442 includes instructions and/or logic therefor, and heuristics and metadata therefor.

In some implementations, the tracking unit 444 is configured to map the physical environment 105 and to track the position/location of at least the electronic device 120 with respect to the physical environment 105 of FIG. 1. To that end, in various implementations, the tracking unit 444 includes instructions and/or logic therefor, and heuristics and metadata therefor.

In some implementations, the coordination unit 446 is configured to manage and coordinate the XR experience presented to the user by the electronic device 120. To that end, in various implementations, the coordination unit 446 includes instructions and/or logic therefor, and heuristics and metadata therefor.

In some implementations, the data transmitting unit 448 is configured to transmit data (e.g., presentation data, location data, etc.) to at least the electronic device 120. To that end, in various implementations, the data transmitting unit 448 includes instructions and/or logic therefor, and heuristics and metadata therefor.

Although the data obtaining unit 442, the tracking unit 444, the coordination unit 446, and the data transmitting unit 448 are shown as residing on a single device (e.g., the controller 110), it should be understood that in other implementations, any combination of the data obtaining unit 442, the tracking unit 444, the coordination unit 446, and the data transmitting unit 448 may be located in separate computing devices.

Moreover, FIG. 4 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 4 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 5 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 502 (e.g., microprocessors, ASICs, FPGAs, GPUs, CPUs, processing cores, and/or the like), one or more input/output (I/O) devices and sensors 506, one or more communication interfaces 508 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 510, one or more XR displays 512, one or more optional interior- and/or exterior-facing image sensors 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 512 are configured to provide the XR experience to the user. In some implementations, the one or more XR displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 512 correspond to diffractive, reflective, polarized, holographic, etc. waveguide displays. For example, the electronic device 120 includes a single XR display. In another example, the electronic device includes an XR display for each eye of the user. In some implementations, the one or more XR displays 512 are capable of presenting MR and VR content.

In some implementations, the one or more image sensors 514 are configured to obtain image data that corresponds to at least a portion of the face of the user that includes the eyes of the user (any may be referred to as an eye-tracking camera). In some implementations, the one or more image sensors 514 are configured to be forward-facing so as to obtain image data that corresponds to the physical environment as would be viewed by the user if the electronic device 120 was not present (and may be referred to as a scene camera). The one or more optional image sensors 514 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 comprises a non-transitory computer readable storage medium. In some implementations, the memory 520 or the non-transitory computer readable storage medium of the memory 520 stores the following programs, modules and data structures, or a subset thereof including an optional operating system 530 and an XR presentation module 540.

The operating system 530 includes procedures for handling various basic system services and for performing hardware dependent tasks. In some implementations, the XR presentation module 540 is configured to present XR content to the user via the one or more XR displays 512. To that end, in various implementations, the XR presentation module 540 includes a data obtaining unit 542, a value determining unit 544, an XR presenting unit 546, and a data transmitting unit 548.

In some implementations, the data obtaining unit 542 is configured to obtain data (e.g., presentation data, interaction data, sensor data, location data, etc.) from at least the controller 110 of FIG. 1. To that end, in various implementations, the data obtaining unit 542 includes instructions and/or logic therefor, and heuristics and metadata therefor.

In some implementations, the value determining unit 544 is configured to determining a plurality of values of an environmental characteristic of a physical environment. To that end, in various implementations, the value determining unit 544 includes instructions and/or logic therefor, and heuristics and metadata therefor.

In some implementations, the XR presenting unit 546 is configured to display, via the one or more XR displays 512, indications of the plurality of values over a virtual representation of the physical environment. To that end, in various implementations, the XR presenting unit 546 includes instructions and/or logic therefor, and heuristics and metadata therefor.

In some implementations, the data transmitting unit 548 is configured to transmit data (e.g., presentation data, location data, etc.) to at least the controller 110. In some implementations, the data transmitting unit 548 is configured to transmit authentication credentials to the electronic device. To that end, in various implementations, the data transmitting unit 548 includes instructions and/or logic therefor, and heuristics and metadata therefor.

Although the data obtaining unit 542, the value determining unit 544, the XR presenting unit 546, and the data transmitting unit 548 are shown as residing on a single device (e.g., the electronic device 120), it should be understood that in other implementations, any combination of the data obtaining unit 542, the value determining unit 544, the XR presenting unit 546, and the data transmitting unit 548 may be located in separate computing devices.

Moreover, FIG. 5 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 5 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a display, non-transitory memory and one or more processors:
displaying a virtual representation of a physical environment;
obtaining, from a physical device at a device physical location in the physical environment, status information indicating a status of the physical device;
displaying, at a device virtual location in the virtual representation of the physical environment corresponding to the device physical location in the physical environment, a virtual representation of the physical device;
determining a plurality of values of an environmental characteristic of the physical environment at a plurality of environment physical locations in the physical environment, wherein the plurality of values are based at least in part on the status information; and
displaying, at a plurality of environment virtual locations in the virtual representation of the physical environment corresponding to the environment physical locations in the physical environment, indications of the plurality of values of the environmental characteristic.

2. The method of claim 1, wherein displaying the virtual representation of the physical environment includes displaying a scale copy of the physical environment.

3. The method of claim 1, wherein displaying the virtual representation of the physical environment includes displaying a two-dimensional floorplan.

4. The method of claim 1, wherein displaying the virtual representation of the physical environment includes displaying a three-dimensional dollhouse.

5. The method of claim 1, wherein displaying the virtual representation of the physical environment includes displaying the virtual representation of the physical environment in association with the physical environment as a world-locked virtual object.

6. The method of claim 5, the world-locked virtual object is displayed with an orientation that matches the physical environment.

7. The method of claim 1, wherein obtaining the status information includes transmitting a query to the physical device and receiving, in response to the query, the status information.

8. The method of claim 1, wherein displaying the virtual representation of the physical device is based at least in part on the status information.

9. The method of claim 1, wherein determining the plurality of values of the environmental characteristic includes determining a plurality of lighting values of the physical environment at the plurality of environment physical locations in the physical environment.

10. The method of claim 1, wherein determining the plurality of values of the environmental characteristic includes determining a plurality of temperature values of the physical environment at the plurality of environment physical locations in the physical environment.

11. The method of claim 1, wherein determining the plurality of values of the environmental characteristic is further based on a model of the physical environment.

12. The method of claim 1, wherein determining the plurality of values of the environmental characteristic is further based on sensor data.

13. The method of claim 1, wherein displaying the indications of the plurality of values of the environmental characteristic includes displaying a heat map.

14. The method of claim 1, further comprising:
receiving user input directed to the virtual representation of the physical device; and
in response to receiving the user input, transmitting, to the physical device, a command to change the status of the physical device.

15. The method of claim 1, further comprising:
receiving user input directed to the indications of the plurality of values of the environmental characteristic; and
in response to receiving the user input, transmitting, to the physical device, a command to change the status of the physical device.

16. The method of claim 1, further comprising:
obtaining, from the physical device, updated status information indicating an updated status of the physical device;
determining a plurality of updated values of the environmental characteristic of the physical environment at the plurality of environment physical locations in the physical environment, wherein the plurality of updated values are based at least in part on the updated status information; and
displaying, at the plurality of environment virtual locations in the virtual representation of the physical environment, indications of the plurality of updated values of the environmental characteristic.

17. The method of claim 1, further comprising:
obtaining additional status information from an additional physical device at an additional device physical location in the physical environment; and
displaying, at an additional device virtual location in the virtual representation of the physical environment corresponding to the additional device physical location in the physical environment, an additional virtual representation of the additional physical device,
wherein determining the plurality of values of the environmental characteristic of the physical environment is further based on the additional status information.

18. The method of claim 1, further comprising:
obtaining, from an additional physical device at an additional device physical location in the physical environment, additional status information indicating a status of the additional physical device;
displaying, at an additional device virtual location in the virtual representation of the physical environment corresponding to the additional device physical location in the physical environment, an additional virtual representation of the additional physical device;
determining an additional plurality of values of an additional environmental characteristic of the physical environment at the plurality of environment physical locations in the physical environment, wherein the additional plurality of values are based at least in part on the additional status information; and
displaying, at the plurality of environment virtual locations in the virtual representation of the physical environment, indications of the additional plurality of values of the additional environmental characteristic.

19. A device comprising:
a display;
a non-transitory memory; and
one or more processors to:
display a virtual representation of a physical environment;
obtain, from a physical device at a device physical location in the physical environment, status information indicating a status of the physical device;
display, at a device virtual location in the virtual representation of the physical environment corresponding to the device physical location in the physical environment, a virtual representation of the physical device;
determine a plurality of values of an environmental characteristic of the physical environment at a plurality of environment physical locations in the physical environment, wherein the plurality of values are based at least in part on the status information; and
display, at a plurality of environment virtual locations in the virtual representation of the physical environment corresponding to the environment physical locations in the physical environment, indications of the plurality of values of the environmental characteristic.

20. A non-transitory memory storing one or more programs, which, when executed by one or more processors of a device including a display, cause the device to:
display a virtual representation of a physical environment;
obtain, from a physical device at a device physical location in the physical environment, status information indicating a status of the physical device;
display, at a device virtual location in the virtual representation of the physical environment corresponding to the device physical location in the physical environment, a virtual representation of the physical device;
determine a plurality of values of an environmental characteristic of the physical environment at a plurality of environment physical locations in the physical environment, wherein the plurality of values are based at least in part on the status information; and
display, at a plurality of environment virtual locations in the virtual representation of the physical environment corresponding to the environment physical locations in the physical environment, indications of the plurality of values of the environmental characteristic.
